(19) United States
(12) Patent Application Publication
(10) Pub. No.: US 2010/0294423 A1
(43) Pub. Date: Nov. 25, 2010

(54) PROTECTIVE FILM FOR LASER PROCESSING AND PROCESSING METHOD USING THE SAME

(75) Inventors: Hironori Takesue, Gunma (JP); Koichi Taguchi, Gunma (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Denki Kagaku Kogyo Kabushiki Kaisha, Tokyo (JP)

(21) Appl. No.: 12/746,277

(22) PCT Filed: Dec. 4, 2008
(86) PCT No.: PCT/JP2008/072010

§ 371 Date: Aug. 12, 2010

(30) Foreign Application Priority Data
Dec. 7, 2007 (JP) 2007-316487

(51) Int. Cl. B32B 38/04; C08K 5/10; B32B 38/00

(52) U.S. Cl. 156/247; 524/315; 156/272.8

(57) ABSTRACT

Disclosed is a protective film for laser processing, which has high adhesiveness and is capable of protecting an object to be processed with a uniform thickness, while being prevented from carbonization/adhesion due to thickness variations. In addition, this protective film for laser processing is free from the problem of waste water contamination when it is removed. Also disclosed is a laser processing method using such a protective film. Specifically disclosed is a protective film for laser processing, which contains a (meth)acrylate copolymer and a radiation-polymerizable (meth)acrylate having an unsaturated bond.

### TECHNICAL FIELD

The present invention relates to a protective film used during processing by irradiation with a laser beam and a processing method using the film.

### BACKGROUND ART

In order to enhance processing speed and to enable dry processing, laser processing is often performed, and ultraviolet lasers, in particular, are often used in various microprocessing applications. However, since the spot processed by the laser beam reaches a state of ultra-high temperature instantaneously, ablation occurs, resulting in a new problem of vaporized materials condensing and adhering to the surface of a workpiece.

In order to solve such problems caused by condensate deposits (debris), Patent Documents 1 to 3 propose processing methods involving formation of a protective film consisting of a water-soluble resin on the work surface of a wafer and irradiation with a laser beam through the protective film.

For example, Patent Documents 1 and 2 describe methods for protecting the surface of a workpiece using a water-soluble protective film. According to these documents, even when laser irradiation-induced condensates (debris) are generated, the debris adheres to the surface of the protective film, and is washed away simultaneously as the protective film is rinsed with water, and thus deposits on a workpiece can thereby be prevented.

Moreover, Patent Document 3 proposes a protective film of a solution in which a water-soluble resin and a laser beam absorbing agent are dissolved.

### Patent Document 1: JP-A S53-8634

### Patent Document 2: JP-A H5-211381

### Patent Document 3: JP-A 2006-140311

### DISCLOSURE OF THE INVENTION

### Problems to be Solved by the Invention

However, the methods of Patent Documents 1, 2 and 3 all obtain a protective film by coating and drying a liquid, and due to uneven coating or unevenness of a workpiece, parts of the protective film can become thicker, and the carbonization and adherence of these thicker parts of the protective film has been a problem.

Moreover, these water-soluble protective films are removed by rinsing with water after processing, and thus waste water pollution has also been a problem.

In other words, the object of the invention is to provide a protective film for laser processing that uniformly protects the entire surface of a workpiece during laser processing, has a high adhesiveness, can effectively prevent debris from adhering, and further solves the problem of waste water pollution, and a processing method using the film.

### Means for Solving the Problems

The protective film for laser processing of the present invention is a film comprising a (meth)acrylic acid ester copolymer and a radiation-polymerizable (meta)acrylate having an unsaturated bond.

The protective film for laser processing consisting of the above constitution has a high adhesiveness, can protect a workpiece with a uniform thickness, and can prevent carbonization and adherence of the protective film caused by uneven thickness. Furthermore, the problem of waste water pollution during the removal of the protective film can also be solved.

In addition, the laser processing method of the present invention is characterized by comprising a laminating step in which the above protective film for laser processing is applied to the surface of a material to be processed, and a laser processing step in which the above material to be processed is irradiated through the above protective film for laser processing.

According to the laser processing method consisting of the above steps, the adhesiveness is high, the workpiece can be protected by a uniform thickness, and the carbonization and adherence of the protective film caused by uneven thickness can be prevented.

Moreover, after the above laser processing step, the method is characterized by further comprising a protective film stripping step in which an adhesive sheet is applied to the above protective sheet for laser processing, the above protective film for laser processing is irradiated by ultraviolet rays to reduce the stripping force of the above protective film for laser processing and the above protective film for laser processing, along with the above adhesive sheet, is stripped away.

According to the laser processing method consisting of the above steps, the problem of waste water pollution during the removal of the protective film can be solved.

### Effects of the Invention

The protective film for laser processing and the processing method using the film of the present invention have a high adhesiveness, can protect a workpiece with a uniform thickness and can prevent the carbonization and adherence of the protective film caused by uneven thickness. Furthermore, the problem of waste water pollution during the removal of the protective film can be solved.

### BEST MODES FOR CARRYING OUT THE INVENTION

Next, an example of the protective film for laser processing of the present invention shall be described. However, the present invention is not limited to this embodiment.

The protective film for laser processing of the present embodiment is a protective film for laser processing in the form of a film comprising a (meth)acrylic acid ester copolymer and a radiation-polymerizable (meth)acrylate having an unsaturated bond.

The protective film for laser processing of the present embodiment, by comprising a (meth)acrylic acid ester copolymer and a radiation-polymerizable (meth)acrylate having an unsaturated bond, has adhesiveness itself, and thus it is possible to attach the protective film on a workpiece with pressure alone.

Moreover, the protective film, as it is in the form of a film, can protect a workpiece with a uniform thickness, and can prevent the carbonization and adherence of the protective film caused by uneven thickness. Furthermore, since the protective film can be removed by applying an adhesive sheet to the protective film, curing it by ultraviolet irradiation and stripping it off, problems such as waste water pollution can be solved.

Additionally, (meth)acrylate in the present specification is a collective term for acrylate and methacrylate. Similarly, (meth)-containing compounds, such as (meth)acrylic acid, collectively refer to compounds having “meth” and compounds not having “meth” in their names.

### (Meth)acrylic Acid Ester Copolymer

The (meth)acrylic acid ester copolymer is not particularly restricted; however, it is a copolymer of at least two kinds of (meth)acrylic acid ester monomers. Examples of the (meth)acrylic acid ester monomer may be butyl(meth)acrylate, 2-butyl(meth)acrylate, t-butyl(meth)acrylate, pentyl (meth)acrylate, octyl (meth)acrylate, 2-ethyl hexyl (meth)acrylate, nonyl (meth)acrylate, decyl (meth)acrylate, lauryl (meth)acrylate, methyl (meth)acrylate, ethyl (meth)acrylate, isopropyl (meth)acrylate, tridecyl (meth)acrylate, myristyl (meth)acrylate, cetyl (meth)acrylate, stearyl (meth)acrylate, cyclohexyl (meth)acrylate, and benzyl (meth)acrylate etc.

Other than the above-indicated (meth)acrylic acid ester, the (meth)acrylic acid ester copolymer may also be copolymerized with a copolymerizable vinyl compound monomer. Examples of the vinyl compound monomer may be a vinyl compound such as ethylene, styrene, vinyl toluene, allyl acetate, vinyl propionate, vinyl butyrate, vinyl versatate, vinyl ethyl ether, vinyl propyl ether, (meth)acrylonitrile, and vinyl isobutyl ether.

A (meth)acrylic acid ester copolymer having a glass transition temperature (Tg) within the range of −40° C. to −10° C. is preferably used. When the glass transition temperature (Tg) is −40° C. or above, the film can continue to be handled as a film. When the glass transition temperature is −10° C. or below, flexibility and adhesiveness of the film can be obtained.

The glass transition temperature (Tg) refers to the temperature at which a macromolecular substance, when heated, changes from a hard vitreous state to a rubbery state and glass transition occurs.

### Radiation-Polymerizable (Meth)acrylate Having an Unsaturated Bond

The radiation-polymerizable (meth)acrylate having an unsaturated bond is not particularly restricted, as long as it has radiation-induced polymerizability; a representative may be a urethane acrylate oligomer, which is a (meth)acrylate having intramolecular urethane bonds. Additionally, trimethylolpropane triacrylate, polyethylene glycol dimethacrylate, dipenterythritol hexacrylate, dipentaerythritol hydroxypentaacrylate, ditrimethylolpropane tetraacrylate, pentaerythritol etoxy tetraacrylate, pentaerythritol tetraacrylate and compounds with methacrylate groups containing a part or all of the acrylate groups of these compounds can also be included as examples.

The amount of the radiation-polymerizable (meth)acrylate having an unsaturated bond is preferably 20 to 200 parts by mass for 100 parts by mass of the (meth)acrylic acid ester copolymer. When the amount is 20 parts by mass or above, stripping of the protective film after irradiation is easy, and when the amount is 200 parts by mass or below, a sufficient stiffness of the film can be obtained and the handling is smooth.

Additionally, if necessary, various additives, for example, adhesion-imparting agents, curing agents, polymerization initiators, softeners, anti-oxidants, fillers, ultraviolet absorbing agents, laser beam absorbing agents and photostabilizers may be added to the protective film for laser processing of the present embodiment.

### Manufacturing Method

The method of manufacturing the protective film for laser processing of the above embodiment is not particularly restricted. For example, it is possible to use a coating machine such as a gravure coater to produce a film of a certain desired thickness on a piece of releasable film.

The above release film has a release agent layer on at least one surface of the film.

A release film is a film coated with a silicon release agent or a non-silicon release agent or the like. For non-silicon release agents, there are those of long-chain alkyl group-containing compounds, alkyd resins, olefin resins, or acrylic resins.

In the present embodiment, the thickness of the release film laminated with the film-like protective film for laser processing is preferably 25 μm to 188 μm. When the thickness of the release film is 25 μm or above, the film has a certain toughness in the manufacturing process, the thickness of the protective film is uniform, and wrinkling does not occur. Moreover, when the thickness of the release film is 188 μm, it is easily handled during the removal, the manufacturing process, and the production of the release film in the form of a roll.

### Laser Processing Method

Laser processing of a workpiece (material to be processed) first involves a step of applying a protective film for laser processing to the workpiece (material to be processed).

As for the method of applying the protective film for laser processing of the above embodiment as the protective film for the workpiece, there is, for example, the method of using a roller or the like to apply the film to the surface of the workpiece (material to be processed).

Then, after the protective film for laser processing is applied to the surface of the workpiece (material to be processed), it is irradiated with a laser beam to carry out the processing.

The laser beam for laser processing can be, for example, a YAG laser fundamental wave (1064 nm), second harmonic wave (532 nm), third harmonic wave (355 nm) and fourth harmonic wave (266 nm) etc. However, the processing precision is poor when a laser beam of 380 nm or above is used, and therefore the wavelength is preferably 380 nm or below.

### Removal of the Protective Film

For the protective film for laser processing of the above embodiment, the method of removing the film-like protective film for laser processing from the workpiece is to apply and let an adhesive sheet thoroughly adhere to the top of the protective film for laser processing, and then to eliminate the adhesive strength of the protective film by irradiating with ultraviolet rays of an adequate wavelength and exposure to cure the film, thereby making it possible to strip off the protective film along with the adhesive sheet.

The adhesive adopted for the adhesive sheet may be an acrylic resin-based adhesive, a natural gum-based adhesive or an ultraviolet-curing type adhesive.

### Effects

Herebelow, the effects of the protective film for laser processing and the processing method using the film of the above embodiment shall be explained.

The protective film for laser processing of the above embodiment is in the form of a film comprising a (meth)acrylic acid ester copolymer and a radiation-polymerizable (meth)acrylate having an unsaturated bond.

The protective film for laser processing has a high adhesiveness, can protect a workpiece with a uniform thickness, can prevent the carbonization and adherence of the protective film caused by uneven thickness, and can further solve the problem of waste water pollution in the removal of the protective film.

Additionally, due to the glass transition temperature of the above (meth)acrylic acid copolymer in the above protective film for laser processing being −40 to −10° C., handling as a film can be maintained and a sufficient flexibility and adhesiveness of the film can be obtained.

Moreover, according to the laser processing method using the protective film for laser processing of the above embodiment, which is a laser processing method characterized by comprising a laminating step in which the above protective film for laser processing is applied to the surface of a material to be processed, and a laser processing step in which the above material to be processed is irradiated with a laser beam through the above protective film for laser processing, a workpiece can be protected by a uniform thickness, and carbonization and adherence of the protective film caused by uneven thickness can be prevented.

Furthermore, after the above laser processing step, by including a protective film stripping step in which an adhesive sheet is applied to the above protective sheet for laser processing, the above protective film for laser processing is irradiated with ultraviolet rays to reduce the stripping force of the protective film for laser processing and the above protective film for laser processing, along with the above adhesive sheet, is stripped, there is no water rinsing step, and therefore the problem of waste water pollution does not occur.

In addition, when the wavelength of the above laser beam is 380 nm and below, processing precision is high, and processing can be carried out at a low cost.

As described above, in the protective film for laser processing and the processing method using the film of the present invention, the protective film itself has adhesiveness, and it is possible to apply the protective film to a workpiece by pressure alone. Moreover, since it is in the form of a film, it is possible to protect a workpiece with a uniform thickness and the carbonization and adherence of the protective film caused by uneven thickness can be prevented. Additionally, since the protective film is removed by applying an ultraviolet-curing type adhesive tape to the protective film and ultraviolet-curing it so as to be able to remove the film by stripping, the problem of waste water pollution or the like can be solved, and the film can be suitably used in the manufacture of semi-conductors and electronic parts microprocessed using lasers.

As described above, the protective film for laser processing and the processing method using the film of the present invention have been explained by providing an example of a possible embodiment. However, the present invention is not restricted to the embodiment.

### EXAMPLES

Herebelow, examples and comparative examples shall be given to further explain the protective film for laser processing and the processing method using the film of the present invention in detail. However, the present invention is not restricted to these examples.

### Protective Film for Laser Processing

First, the protective film for laser processing shall be explained.

The protective film for laser processing of the present invention is characterized by being in the form of a film comprising a (meth)acrylic acid ester copolymer, and a radiation-polymerizable (meth)acrylate having an unsaturated bond.

The (meth)acrylic acid ester copolymer used in the protective film for laser processing was a copolymer of butyl acrylate at 75% by mass, methyl methacrylate at 20% by mass, 2-hydroxyethyl acrylate at 5% by mass, and the glass transition temperature Tg was −32.8° C.

Moreover, the radiation-polymerizable (meth)acrylate having an unsaturated bond is a urethane acrylate oligomer that is a reaction product of urethane acrylate oligomer:isophorone diisocyanate and pentaerythritol triacrylate. The number average molecular weight (Mn) is 600 and the number of vinyl groups is 6 per molecule.

The photopolymerization initiator is 1-hydroxycyclohexyl phenyl ketone-based. The curing agent is a tolylene diisocyanate adduct of trimethylolpropane.

A film-like protective film for laser processing 1 was prepared by combining 100 parts by mass of the (meth)acrylic acid ester copolymer, 100 parts by mass of the radiation-polymerizable (meth)acrylate having an unsaturated bond and 5 parts by mass of the curing agent to produce a film with a thickness of 5 μm.

A film-like protective film for laser processing 2 was prepared by combining 100 parts by mass of the (meth)acrylic acid ester copolymer, 100 parts by mass of the radiation-polymerizable (meth)acrylate having an unsaturated bond, 3 parts by mass of the photopolymerization initiator and 5 parts by mass of the curing agent to produce a film with a thickness of 5 μm.

A film-like protective film for laser processing 3 was prepared by combining 100 parts by mass of the (meth)acrylic acid ester copolymer, 100 parts by mass of the radiation-polymerizable (meth)acrylate having an unsaturated bond, 3 parts by mass of the photopolymerization initiator and 5 parts by mass of the curing agent to produce a film with a thickness of 20 μm.

A film-like protective film for laser processing 4 was prepared by combining 100 parts by mass of the (meth)acrylic acid ester copolymer, 100 parts by mass of the radiation-polymerizable (meth)acrylate having an unsaturated bond, 3 parts by mass of the photopolymerization initiator and 5 parts by mass of the curing agent to produce a film with a thickness of 10 μm.

### Release Film

Next, a release film A that is placed on the protective film for laser processing shall be explained.

Release film A was a 38 μm-thick polyethylene terephthalate film with one surface coated with an addition reaction type silicon resin release layer that, when assessed according to JIS Z 0237:2000 10.4.1, had a light release grade 100 mN/50 mm peel force from the protective film layer .

Additionally, the specifications of the laser processing machine used in the present examples and comparative examples are as follows.

Laser beam source: YAG laser

Wavelength: 355 nm

Repetition frequency: 50 -100 kHz

Output: 0.3 -4.0 W

Focal spot diameter: φ9.2 μm

Processing feed rate: 1 -800 mm/sec.

Next, examples and comparative examples using the above release film and protective film for laser processing shall be explained.

### Example 1

A film-like protective film for laser processing 1 laminated with a release film A was applied to a silicon wafer using a roller. Release film A was stripped off to produce a protective film-covered silicon wafer. Laser processing was then performed.

After laser processing, a commercial UV curing type dicing tape (Elegrip Tape UHP-110M3, manufactured by Denki Kagaku Kogyo Kabushiki Kaisha) was applied to the protective film on the protective film-covered silicon wafer, the back surface of the dicing tape was irradiated with ultraviolet rays of 150 mJ/cm² using a high-pressure mercury lamp to cure the dicing tape so that when stripped, the protective film could also be stripped off. The laser processed area was examined, and it was in a good processed state with no remnants of the protective film or adherence of debris.

### Example 2

Other than using a film-like protective film for laser processing 2, the exact same test as Example 1 was carried out. The protective film was removed using a commercially available UV curing type dicing tape and the laser processed area was examined. The area was in a good processed state with no remnants of the protective film or adherence of debris.

### Example 3

Other than using a film-like protective film for laser processing 3, the exact same test as Example 1 was carried out. The protective film was removed using a commercially available UV curing type dicing tape and the laser processed area was examined. The area was in a good processed state with no remnants of the protective film or adherence of debris.

### Example 4

Other than using a film-like protective film for laser processing 4, the exact same test as Example 1 was carried out. The protective film was removed using the commercial UV curing type dicing tape and the laser processed area was examined. The area was in a good processed state with no remnants of the protective film or adherence of debris.

The experimental results of the above Examples 1 to 4 are shown in Table 1. Additionally, the criteria for evaluating the formation of the protective film in Table 1 are, “O” when a protective film with a uniform thickness was formed, and “x” when a protective film could not be formed due to stretching and tearing. Moreover, after the protective film was removed, “O” was given when there were no residues, such as remnants of the protective film or debris, and “x” was given when residues were observed.

### Comparative Example 1

A water-soluble protective film was coated on a silicon wafer using a spin coater and dried to form a 3 to 5 pm thick protective film, resulting in a protective film-coated silicon wafer. The same test as Example 1 was then carried out.

After laser processing, the protective film was rinsed with pure water and the laser processed area was examined. Remnants of the protective film and a small amount of debris were observed on a part of the edge of the processed area. The results are shown in Table 1.

TABLE 1

| | | | | | Comparative |
|---|---|---|---|---|---|
| | Example 1 | Example 2 | Example 3 | Example 4 | Example 1 |
| Release Film | A | A | A | A | n/a |
| Protective Film for | 1 | 2 | 3 | 4 | Water-soluble |
| Laser Processing | | | | | |
| Protective Film | ∘ | ∘ | ∘ | ∘ | ∘ |
| Formation | | | | | |
| Residues after | ∘ | ∘ | ∘ | ∘ | x |
| Removal | | | | | |

As shown above, when the protective films for laser processing of Examples 1-4 of the present invention were used, there were no remnants of the protective film or adherence of debris and the processed state was good.

Moreover, when the protective film for laser processing of the present invention is used to perform laser processing with methods such as the one above, rinsing with water is not needed for the removal of the protective film, and therefore the problem of waste water pollution does not occur.

1. A protective film for laser processing in the form of a film comprising a (meth)acrylic acid ester copolymer and a radiation-polymerizable (meth)acrylate having an unsaturated bond.

2. A protective film for laser processing as recited in claim 1, characterized in that the glass transition temperature of said (meth)acrylic acid ester copolymer is −40 to −10° C.

3. A laser processing method using the protective film for laser processing as recited in claim 1, the laser processing method being characterized by comprising a laminating step of applying said protective film for laser processing to the surface of a material to be processed, and a laser processing step of irradiating said material to be processed with a laser beam through said protective film for laser processing.

4. A laser processing method as recited in claim 3, characterized by further comprising, after said laser processing step, a protective film stripping step of applying
an adhesive sheet to said protective film for laser processing,
irradiating said protective film for laser processing with ultraviolet rays to reduce the stripping force of the protective film for laser processing, and
stripping away said protective film for laser processing, along with said adhesive sheet.

5. A laser processing method as recited in claim 3, wherein the wavelength of said laser beam is 380 nm or below.
